(19) United States
(12) Patent Application Publication
(10) Pub. No.: US 2006/0023566 A1
(43) Pub. Date: Feb. 2, 2006

(54) Device for making an alimentary emulsion

(76) Inventors: Jacques Fouquet, Lyon (FR); Nicolas Fouquet, Lyon (FR)

Correspondence Address: Ralph A. Dowell of DOWELL & DOWELL P.C., 2111 Eisenhower Ave., Suite 406, Alexandria, VA, 22314, US

(21) Appl. No.: 11/189,114

(22) Filed: Jul. 26, 2005

(30) Foreign Application Priority Data
Jul. 30, 2004 (FR) 04 08486

(51) Int. Cl. B01F 13/00

(52) U.S. Cl. 366/207

(57) ABSTRACT

This invention relates to a device for making an alimentary emulsion from at least one initial ingredient, comprising a fixed body, as well as a mobile stirring member intended to plunge at least in part into the or each initial ingredient, this mobile member being adapted to be driven in rotation about its principal axis, characterized in that the mobile member comprises a rod, as well as a stirring sphere, intended to plunge into the or each initial ingredient, this sphere being provided at one end of this rod.

### FIELD OF THE INVENTION

The present invention relates to a device for making an alimentary emulsion.

The device according to the invention is more particularly, but not exclusively, an apparatus known under the name of “shaker”, intended in particular for bars, ice-cream bars, hotels or restaurants. This apparatus enables beverages based on milk and syrup, of the “milk shake” type, and beverages of the “cocktail” type, alcoholic or not, based on milk, flavoured ice-cream or alcohol, to be made.

However, the device of the invention is applicable to types of alimentary emulsions other than the beverages mentioned above. For example, the operation consisting in beating egg yolks will be mentioned solely by way of indication.

### BACKGROUND OF THE INVENTION

Devices for making an alimentary emulsion are known, which comprise a fixed body, as well as a mobile stirring member, intended to penetrate in the ingredient or ingredients serving as base for the emulsion. The free end of this mobile member is provided with a wavy stirrer, or with a finned stirrer.

This being specified, the invention aims at proposing a device for making alimentary emulsions whose quality is improved with respect to the prior art, in particular by an increase in the final volume of this emulsion.

### SUMMARY OF THE INVENTION

To that end, it has for its object a device for making an alimentary emulsion from at least one initial ingredient, comprising a fixed body, as well as a mobile stirring member intended to plunge at least in part into the or each initial ingredient, this mobile member being adapted to be driven in rotation about its principal axis, characterized in that the mobile member comprises a rod, as well as a stirring sphere, intended to plunge into the or each initial ingredient, this sphere being provided at one end of this rod.

### BRIEF DESCRIPTION OF THE DRAWINGS

The invention will be more readily understood and other advantages thereof will appear more clearly in the light of the following description of a form of embodiment of a device for making an alimentary emulsion in accordance with its principle, given solely by way of non-limiting example and made with reference to the accompanying drawings, in which:

FIG. 1 is a view in perspective, illustrating the device according to the invention, in its position of rest; and

FIG. 2 is a view in perspective, similar to FIG. 1, illustrating this device in its position of use, namely associated with a recipient.

### DESCRIPTION OF PREFERRED EMBODIMENT

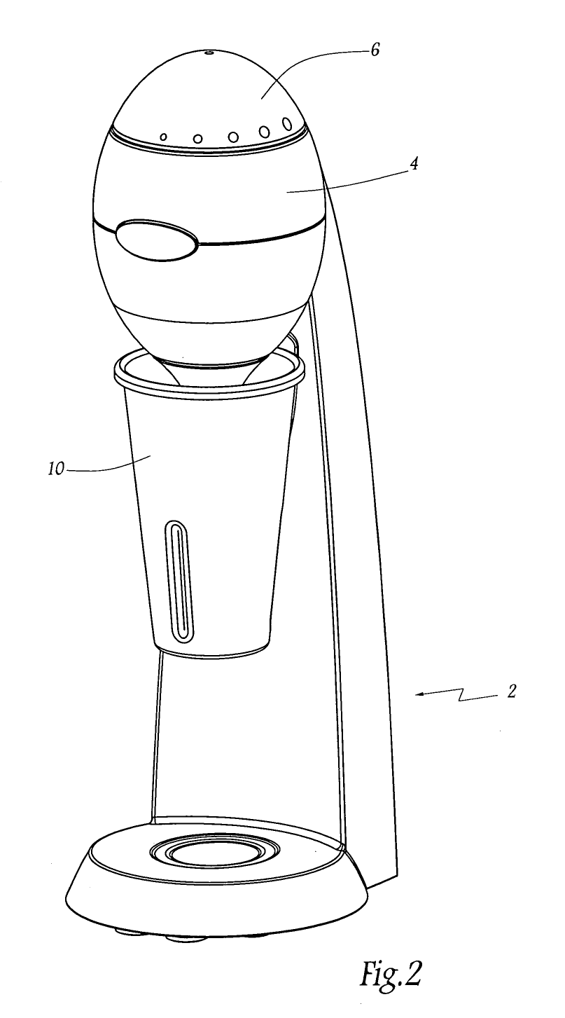

Referring now to the drawings, the device according to the invention comprises, in manner known per se, a body 2, as well as an upper housing 4 in which a motor (not shown) is housed. A regulator 6 is also provided, making it possible, in conventional manner, to change the speed of rotation of the motor, as well as a support 8 adapted to receive a recipient 10, visible in FIG. 2.

The device according to the invention is also provided with a mobile stirring member, generally designated by reference 12. This member 12, which is adapted to be driven in rotation by the motor about its principal axis X′-X, comprises a rod 12, extending from the housing, as well as a sphere 12₂ provided at the lower end of the rod 12₁.

Mutual fixation of this rod and this sphere is ensured removably, for example by screwing. By way of variant, the rod and the sphere may be fixed permanently, in particular by gluing. By way of additional variant, this rod and this sphere may be made in one piece.

In the example illustrated, the sphere 12₂ is smooth. However, by way of variant, it may be provided with rough parts whose dimension is very much smaller than the global diameter of the sphere. In this example, the rod 12₁ presents a form of revolution, with the result that its walls are also smooth.

This sphere may be made of a relatively hard material, such as a plastics material, particularly polycarbonate or polypropylene. By way of variant, the material constituting the sphere may be relative supple, particularly when it is provided with rough parts. In that case, it may for example be an elastomer, such as synthetic rubber.

By way of non-limiting example, the diameter D of the sphere 12₂ is included between 10 and 60 mm, in particular between 20 and 40 mm. This diameter is for example close to 30 mm.

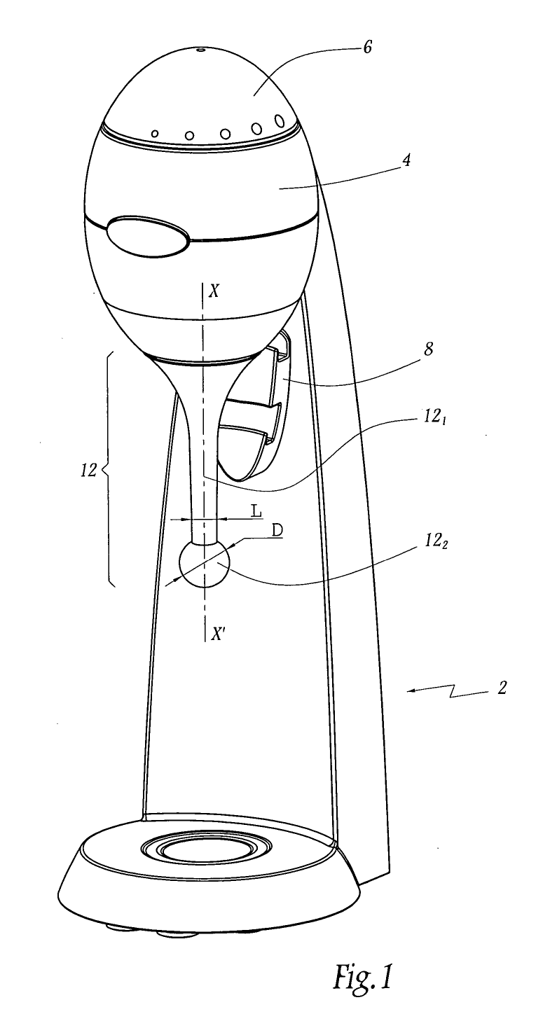

As is particularly visible in FIG. 1, this diameter D of the sphere 12₂ is advantageously clearly greater than the width L of the rod 12₁, this width being taken in the vicinity of the rod with the sphere. This ratio D/L is advantageously included between 1.5 and 4, particularly between 2 and 3.

In service, as shown in FIG. 2, the recipient 10 is firstly placed on the support 8, said recipient being filled with at least one ingredient intended to form an alimentary emulsion. For example, it is question of milk and syrup, intended to form a milk shake.

Once the recipient 10 is placed in position, the sphere 122 as well as part of the rod 12, penetrate in the interior volume of the recipient 10, so as to plunge into the initial ingredients. The mobile member 12 assembly is then made to rotate about the principal axis X′-X of the rod 12₁.

This operation is carried out within conventional speed ranges, namely included in particular between 10,000 and 15,000 rpm. An alimentary emulsion is then obtained, in the present case a milk shake, from the initial ingredients mentioned above.

It will be noted that the person skilled in the art is capable of adjusting different parameters of the device according to the invention, in order to optimize the quality of the final emulsion. It is question in particular of the diameter of the sphere, its position inside the recipient, and the speed of rotation of the mobile member.

The invention enables the objects set forth hereinabove to be attained.

In effect, Applicants have ascertained that the fact of integrating a sphere in the mobile stirring member substantially improves the quality of the emulsion thus obtained. In particular, this emulsion presents a volume notably greater than those obtained in the prior art, from the same quantities of ingredients.

This improvement in quality of the emulsion is particularly substantial in the case of the diameter of the sphere being clearly greater than the width of the rod. In effect, tests carried out in this configuration allow a volume of emulsion greater by at least 20% than that obtained by the devices of the state of the art.

Furthermore, the mobile stirring member of the invention proves to be particularly easy to clean, in particular when the sphere is removably fixed on the rod. Finally, this mobile member is substantially non-aggressive for the user, compared to the prior art which employs a stirrer with projecting shapes, particularly fins. In this respect, it will be noted that the invention allows high performances, while guaranteeing very satisfactory safety, particularly when the rod and the sphere are smooth.

What is claimed is:

1. Device for making an alimentary emulsion from at least one initial ingredient, comprising a fixed body, as well as a mobile stirring member intended to plunge at least in part into the or each initial ingredient, this mobile member being adapted to be driven in rotation about its principal axis, wherein the mobile member comprises a rod, as well as a stirring sphere, intended to plunge into the or each initial ingredient, this sphere being provided at one end of this rod.

2. The device of claim 1 for making an alimentary emulsion, wherein the rod and the sphere are removably fixed to each other, in particular by screwing.

3. The device of claim 1 for making an alimentary emulsion, wherein the sphere and the rod are permanently fixed to each other, in particular by gluing, or are made in one piece.

4. The device of claim 1 for making an alimentary emulsion, wherein the rod and the sphere are smooth.

5. The device of claim 1 for making an alimentary emulsion, wherein the sphere is made of a plastics material, in particular of polycarbonate or polypropylene.

6. The device of claim 1 for making an alimentary emulsion, wherein the sphere is made of an elastomeric material, in particular of rubber.

7. The device of claim 1 for making an alimentary emulsion, wherein the sphere presents a diameter included between 10 and 60 mm, in particular between 20 and 40 mm.

8. The device of claim 7 for making an alimentary emulsion, wherein the sphere presents a diameter close to 30 mm.

9. The device of claim 1, wherein the diameter of the sphere is clearly greater than the width of the rod, this width being taken in the vicinity of this rod with the sphere.

10. The device of claim 9, wherein the ratio between the diameter of the sphere and the width of the rod is included between 1.5 and 4, preferably between 2 and 3.
